(19) United States
(12) Patent Application Publication
(10) Pub. No.: US 2005/0271797 A1
(43) Pub. Date: Dec. 8, 2005

(54) Method for manufacturing high power electrode for lithium secondary battery

(76) Inventors: Seong-Hwan Na, Changwon-si (KR); Hyun-Soo Kim, Changwon-si (KR); Seong-In Moon, Changwon-si (KR); Chil-Hoon Doh, Changwon-si (KR)

Correspondence Address: Robert E. Bushnell, Suite 300, 1522 K Street, N.W., Washington, DC, 20005, US

(21) Appl. No.: 11/132,185

(22) Filed: May 19, 2005

(30) Foreign Application Priority Data
Jun. 7, 2004 (KR) 10-2004-0041258

(51) Int. Cl. B05D 5/12

(52) U.S. Cl. 427/58; 427/126.3; 427/126.6

(57) ABSTRACT

A method for manufacturing a high power electrode for a lithium secondary battery contemplates (a) preparing EC (ethylene carbonate) solution by dissolving EC crystals in a suitable solvent; (b) dissolving a binder in a suitable solvent to make a binder solution, and then adding and sufficiently mixing into the binder solution, an active electrode material and an electrically conductive material of a desired composition; (c) adding a predetermined amount of the EC solution prepared in the step (a) to the binder solution obtained in the step (b); (d) stirring the mixture of the EC solution and the binder solution sufficiently to make a slurry as an electrode binder to be coated on an electrode; (e) coating the slurry onto a collector; (f) sufficiently drying the coated slurry at a predetermined temperature; and (g) making a final electrode by compressing a dried electrode structure at a predetermined pressure after the coated slurry is dry.

### CLAIM OF PRIORITY

This application makes reference to, incorporates the same herein, and claims all benefits accruing under 35 U.S.C. §119 from an application entitled METHOD FOR MANUFACTURING HIGH POWER ELECTRODE FOR LITHIUM SECONDARY BATTERY filed with the Korean Intellectual Property Office on 7 Jun. 2004, and there duly assigned Serial No. 2004-41258.

### BACKGROUND OF THE INVENTION

1. Field of the Invention

The present invention relates to high power electrodes for rechargeable lithium batteries and methods for manufacturing high power electrodes for lithium rechargeable batteries and, more particularly, to a method for manufacturing high power electrodes for lithium secondary batteries, which endows the batteries with an enhanced current discharge capacity.

2. Description of the Related Art

As appliances such as mobile phones and notebook computers become smaller and lighter, a higher performance battery is required. In particular, we have discovered that there is an urgent need for development of an electrode that may show excellent performance when discharging high current to an electrically powered appliance, tool or an electrically powered automobile. Currently however, it is difficult to develop a commercial version of a conventional high power electrode due to many problems such as the complexity of the processes which must be used for its manufacture, the increasing costs of materials used in its manufacture, the limited processing capability of contemporary manufacturing facilities, and the like.

As the need for higher performance by lithium secondary batteries becomes more acute, a new high power electrode that may overcome the limitations of existing electrodes for lithium secondary batteries should be developed without delay. Until now, the electrode for PLI (polymer Lithium ion) produced by Bellcore Co. in USA (i.e., Bell Communications Research Inc., Livingston, N.J.) has been a substantiallyunique high power electrode. Essentially, to make this electrode, the Bellcore Co. adds DBP (dibutyl phthalate) excessively, together with NMP (n-methyl pyrrolidone) which is capable of melting the PVDF (poly-vinylidene fluoride) that is used to make an electrode binder with the consistency of a slurry. DBP is then extracted from a solvent such as methanol and ether, so that micro-pores are formed in the electrode in order that an electrolyte may easily penetrate into the electrode via the pores.

This type of electrode manufactured by Bellcore Co. is expensive to manufacture, and concomitantly causes economic, environmental and logistical problems because DBP, which is environmentally classified as an environmental hormone, is used as a medium for forming the pores and the DBP should be extracted subsequently in a solvent such as either methanol or ether. In particular, because the current Fire Service Act prohibits processing of methanol in quantities greater than 200L, previous efforts to improve battery production and logistics that require mass production has been hindered by many obstacles.

### SUMMARY OF THE INVENTION

The present invention is designed to solve the problems attendant to conventional electrode manufacturing methods, and therefore, it is an object of the present invention to provide a method for manufacturing a high power electrode for a lithium secondary battery.

It is another object to provide a method for enhancing the current discharge capacity of electrodes for lithium secondary batteries.

It is still another object to provide a method for treating electrodes for rechargable lithium batteries to create pores within the electrodes that accommodate free movement of an electrolyte via the pores.

It is yet another object to provide a method for inexpensively creating micro-pores within electrodes for rechargeable lithium batteries.

It is still yet another object to provide a method for manufacturing electrodes of lithium secondary batteries to permit an electrolyte to move freely into pores formed in the electrodes.

It is a further another object to provide a method for treating electrodes while manufacturing lithium batteries to enable an electrolyte to move freely into pores in the electrodes.

It is a still further object to provide a method that is capable of improving a high current discharge capacity of a battery by forming micro pores in the electrode for a lithium secondary battery in a cheap and easy way so that electrolyte may freely move into the pores while the battery is manufactured.

In order to accomplish these and other objects, the present invention provides a method for manufacturing a high power electrode for a lithium secondary battery by (a) preparing an EC (ethylene carbonate) solution by dissolving EC crystals in a suitable solution; (b) separately dissolving a binder in a suitable solution to make a binder solution, and then adding and mixing with the binder solution an active electrode material and an electrically conductive material of a desired composition; (c) adding a predetermined amount of the EC solution prepared in step (a) to the solution obtained in step (b) and stirring the combination sufficiently to make a slurry for use as an electrode binder that may be coated on an electrode; (d) coating a collector with the slurry and sufficiently drying the coated slurry at a predetermined temperature; and (e) forming a final electrode by compressing the dried electrode structure at a predetermined pressure after the coated slurry has been dried.

Before the slurry is coated on the collector in step (d), a step of degassing the slurry in a vacuum may preferably be included.

The range of temperatures which may be used in step (d) while drying the coated slurry is preferably kept in the range of between approximately 120° C. to approximately 140° C.

The range of pressures that may be used for the compression performed in step (e) is preferably kept in the range of approximately 500 kg/square centimeter to approximately 1500 kg/square centimeter.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a flowchart illustrating a method for manufacturing a high power electrode for lithium secondary batteries according to the principles of the present invention;

FIGS. 2a through 2d present a sequence of cross-sectional schematic views that illustrate process steps that may be taken during the manufacture of lithium ion secondary batteries constructed with electrodes manufactured according to the principles of the present invention;

FIG. 3a is a two-coordinate graph showing a rate capability of a battery constructed with a high power electrode manufactured according to the principles of the present invention;

FIG. 3b is a two-coordinate graph showing a rate capability of a battery using a conventionally manufactured electrode;

FIG. 4a is a two-coordinate graph showing a life cycle of a battery constructed with a high power electrode manufactured according to the principles of the present invention; and

FIG. 4b is a two-coordinate graph showing a life cycle of a battery using a conventionally manufactured electrode.

### DESCRIPTION OF THE PREFERRED EMBODIMENT

Hereinafter, the present invention will be described in more detail by referring to these accompanying drawings.

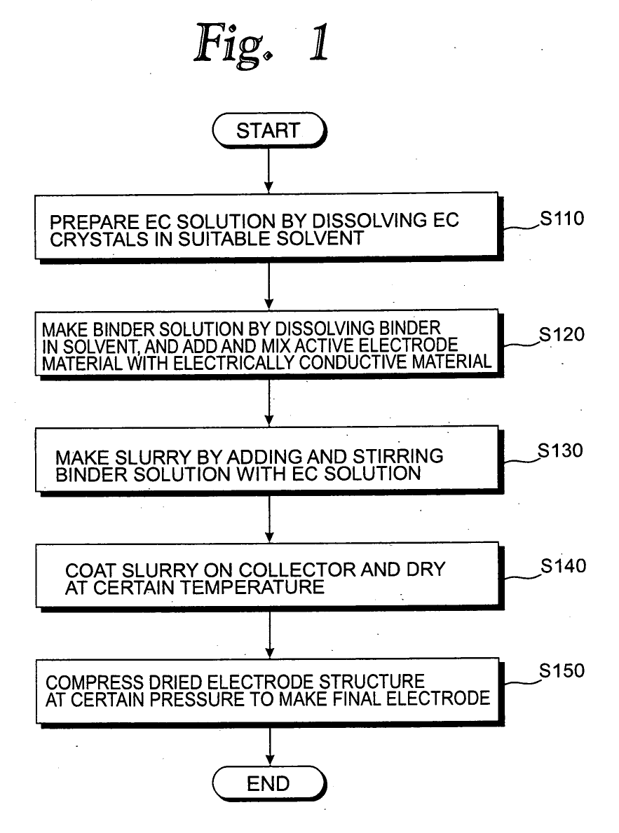

FIG. 1 is a flowchart for illustrating a method for manufacturing a high power electrode for a lithium secondary battery according to the principles of the present invention.

Referring to FIG. 1, in this method, first in step S110, EC (ethylene carbonate) crystals are dissolved in a suitable solvent to prepare a liquid phase EC solution. Here, the solvent may use acetone, acetonitrile, NMP (n-methyl pyrrolidone) and so on. The reason for dissolving EC in an organic solvent such as acetone, acetonitrile and NMP is that EC is in a solid phase state that is not easily dispersed in the electrode.

If the EC solution is prepared, a binder is dissolved in a suitable solvent to make a binder solution, and then to this binder solution is added an active electrode material and an electrically conductive material of a desired composition; the resulting solution is then sufficiently mixed (step S120). Here, the binder may be selected from among PVDF (poly-vinylidone fluoride), HFP (hexafluoropropylene) and so on, and the solvent may be chosen from among NMP, acetone and so on. In addition, the active electrode material may be selected from among LiCoO2, LiNixMnyCo(1-x-y)O2, LiMn2O4, LiNiO2 and so on, and the electrically conductive material may be carbon black.

If the active electrode material and the conductive material are added to the binder solution, and the resulting solution is sufficiently stirred, a small amount of the EC solution prepared in step S110 is then added to the binder solution, and then the binder solution is sufficiently stirred to make a slurry. That slurry may be used as an electrode binder to be coated onto the electrode (step S130). Here, an amount of the EC solution added to the binder solution is determined on the basis of an exact calculation of a ratio occupied by EC present in the electrolyte to be used in the battery.

If the slurry is made as an electrode binder to be coated on the electrode, the slurry is coated on a collector (commonly, aluminum foil is used as a cathode and copper foil is used as an anode in a lithium secondary battery) and the electrode binder is then dried sufficiently at a predetermined temperature (step S140). Before the slurry is coated onto the collector, a process of degrassing the slurry in a vacuum is preferably executed. In addition, although there are some differences, depending on features of the electrode, the temperature for drying the slurry already coated onto the collector is preferably kept within the range of approximately 120° C. to approximately 140° C. so that the organic solvent included in the slurry can not remain. Here, by means of the drying process, the organic solvent is evaporated from the slurry and removed, thereby making an electrode structure in which only active material, binder, electrically conductive material, and solid EC remain.

If the drying process is completed as mentioned above, the dried electrode structure is then compressed at a predetermined pressure to make a final electrode (step S150). Here, the pressure applied to the electrode structure is preferably in the range of approximately 500 kg/square centimeter to approximately 1500 kg/square centimeter, though it may be changed, depending on kind and usage of the electrode.

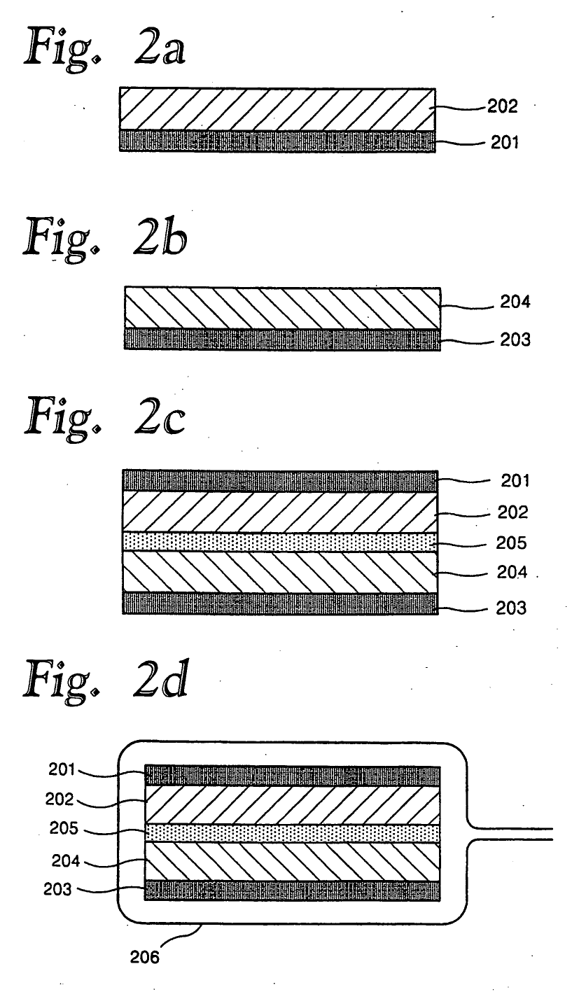

FIGS. 2a through 2d sequentially illustrate the processes of manufacturing a lithium ion secondary battery using an electrode made by the method of the present invention.

Referring to FIG. 2a, the final electrode made by the method of the present invention is shown, in which reference numeral 201 denotes a cathode collector, and a reference numeral 202 denotes an electrode binder (in the form of a slurry) for a cathode.

In addition, as shown in FIG. 2b, graphite which may be used for the active anode 8 material, Super-P (carbon black) which maybe used for the electrically conductive material, and PVDF which may be used for the binder are mixed at a ratio of 90:2:8 (wt %), and the mixture is then coated on a copper foil anode collector 203, and then they are dried and compressed to make an anode 204. Here, the active anode material may be graphite or other carbon materials that allow insertion and extraction of lithium ions.

After that, the cathode 202 of the cathode structure shown in FIG. 2a and the anode 204 of the anode structure shown in FIG. 2b are positioned to be opposite to each other, and the cathode structure and the anode structure are laminated in a way that a separator (made of polyethylene or polypropylene) 205 is interposed between cathode 202 and anode 204 as shown in FIG. 2c.

After that, as shown in FIG. 2d, the laminated structure is wrapped with a packaging material such as an aluminum laminate film 206. Here, aluminum laminate film 206 is composed of a plastic layer made of PET, Nylon or the like, an aluminum layer and an adhesive layer. In addition, the casing formed by aluminate film 206 is filled with an electrolyte such as a mixture liquid such as EC (ethylene carbonate), PC (propylene carbonate), DEC (diethyl carbonate), DMC (dimethyl carbonate) and EMC (ethyl methyl carbonate), which contains LiPF₆ as lithium salts, and then the assembly represented by FIG. 2d is compressed while in a vacuum to make a lithium ion secondary battery.

Here, an electrolyte of the lithium secondary battery is generally obtained by mixing EC (ethylene carbonate), PC (propylene carbonate), DEC (diethyl carbonate), DMC (dimethyl carbonate), EMC (ethyl methyl carbonate), and so on at appropriate ratios. The electrolyte used for making a lithium secondary battery using an electrode constructed according to the principles of the present invention already contains EC components, among other components, in the electrode, so that all of the components of the electrolyte, except EC, are mixed together and then aged for approximately ten hours so that EC may be sufficiently dissolved in the mixture.

In addition, most of the components of the electrolyte except EC, are in a liquid state at a room temperature, but at room temperature EC is in a solid state. When the electrode is manufactured, if an electrolyte that is free of the presence of EC is supplied, the electrolyte penetrates into the electrode. Accordingly, the EC is leached out from the electrode as an electrolyte, so that empty spaces generated by the leaching-out of the EC become micro-pores through the electrode, thereby improving a high current discharge capacity of the electrode. In addition, the micro-pores also provide a buffering function that relieves stress and strain which is caused to the active material when lithium ions are inserted or extracted, so that the life cycle of the battery is concomitantly improved.

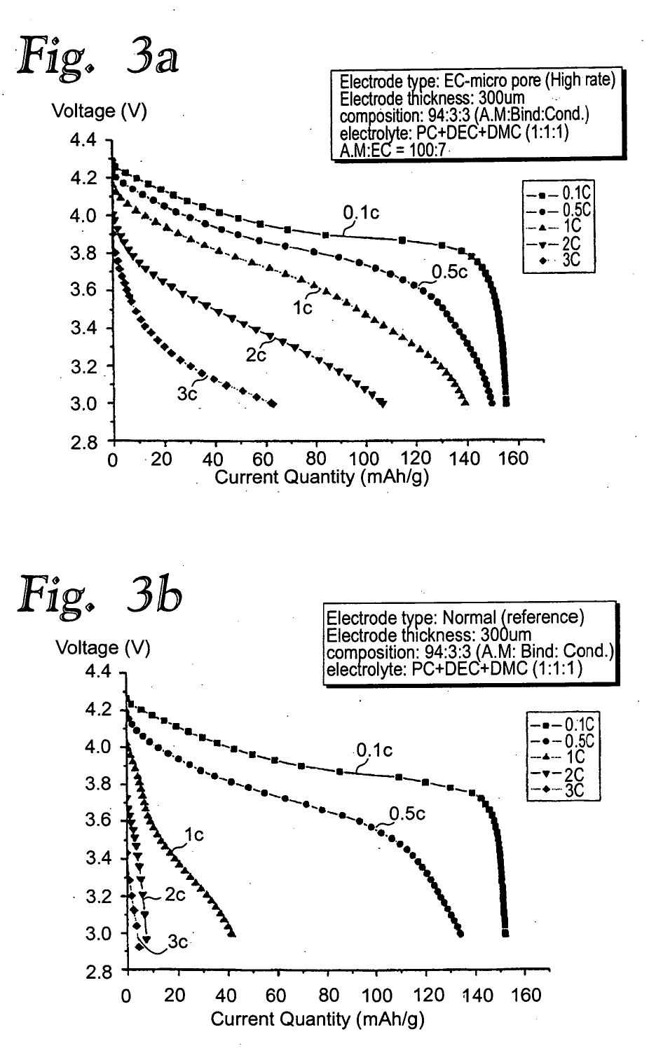

Meanwhile, FIGS. 3a and 3b show rate capability of batteries respectively, in which FIG. 3a is a graph showing the rate capability of a battery using a high power electrode made by the method of the present invention, and FIG. 3b is a graph showing the rate capability of a battery using a conventional manufactured electrode.

FIG. 3a is a per-rate discharge graph obtained by measuring capacities of a lithium ion secondary battery assembled to incorporate an electrode containing EC as a function of changing current density after the battery has been charged to 4.3V.

The electrode was made with components LiCoO2: Super-P:PVDF in a ratio 94:3:3 percent by weight, and 7% of EC was added on the basis of the amount by weight of LiCoO2 when the electrode was manufactured. This amount of EC was selected to make the component of the electrolyte have a final ratio by weight of EC:PC:DEC:DMC=1:1:1:1, so the electrolyte actually supplied has a composition ratio percentage by weight of PC:DEC:DMC=1:1:1 without any EC being present among the final electrolyte components. The amount of electrolyte supplied was adjusted to 3.5 grams per one Ampere-hour of designed discharge capacity. If the thickness of the electrode is increased, the diffusion length of lithium ions is elongated, so the rate capability of the battery is decreased. Since the present invention is mainly focused on improvement of rate capability of batteries, a thick electrode with a thickness of about 300 millimeters was made and used in order to specify its improved degree. Considering that an electrode of a commercialized battery has a thickness of 145 mm or less, an electrode having about twice that thickness was used to measure battery characteristics.

FIG. 3b is a per-rate discharge graph of a lithium ion secondary battery assembled using an electrode that is free from EC such as a conventionally manufactured electrode, after a charge of 4.3V. The electrode was made with a composition of LiCoO2: Super-P:PVDF in a ratio percentage by weight of 94:3:3, and an electrolyte supplied that had a composition of EC: PC: DEC:DMC in a ratio percentage by weight of 1:1:1:1, so that the electrolyte actually supplied for the battery represented by FIG. 3b had a composition of PC: DEC:DMC in a ratio by weight of 1:1:1 without an EC component being present among the final electrolyte components. The electrode was also made relatively thick with a thickness of about 300 millimeters for comparison, and the amount of the electrolyte supplied was adjusted to 3.5 grams per one Ampere-hour of the designed discharge capacity of the battery.

For reference, as used in FIGS. 3a and 3b, a 0.1C current density is an electrical current density capable of discharging a battery in ten hours, and a 0.5C current density is a current density capable of discharging a battery in two hours. A 1C current density is a current density capable of discharging a battery in an hour, and a 2C current density is a current density capable of discharging a battery in one-half of an hour.

By comparing the graphs of FIGS. 3a and 3b, it may be seen that a battery using an electrode made by the method of the present invention shows improved rate capability in comparison to a battery using a conventionally manufactured electrode. It may be more clearly understood from the following Table 1 in which the graphical data are shown by numbers.

TABLE 1

| | |
|---|---|
| EC micro-pore electrode | Conventional electrode |

| | | Capacity | Rate to | Capacity | Rate to |
|---|---|---|---|---|---|
| | | (mAh/g) | 0.1 C (%) | (mAh/g) | 0.1 C (%) |
| 0.1 | C | 155.1 | 100 | 152.0 | 100 |
| 0.5 | C | 149.5 | 96.4 | 134.0 | 88.2 |
| 1 | C | 139.1 | 89.7 | 41.4 | 27.2 |
| 2 | C | 106.6 | 68.7 | 7.46 | 4.90 |
| 3 | C | 62.8 | 40.5 | 4.43 | 2.91 |

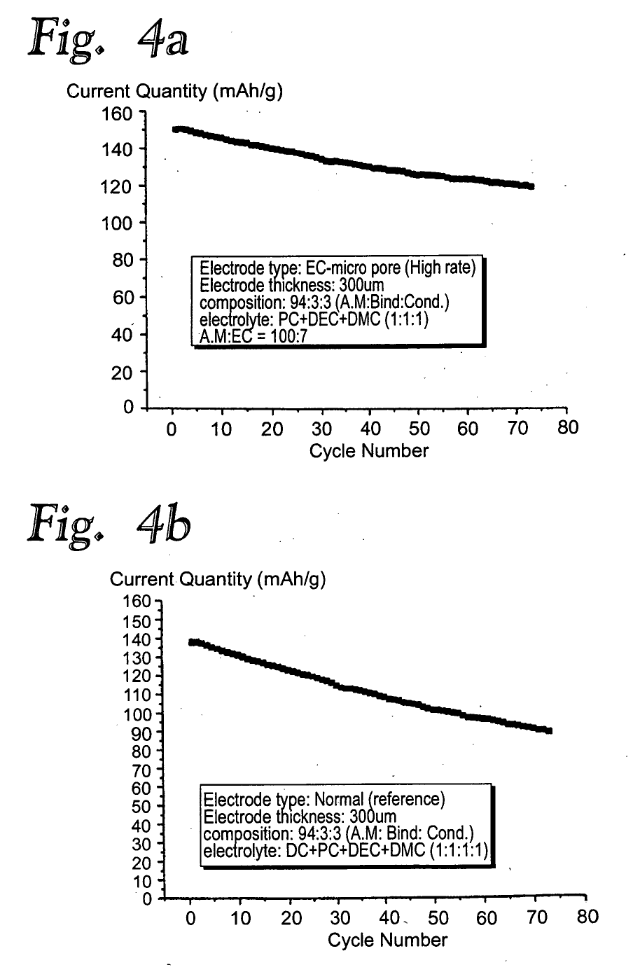

FIGS. 4a and 4b show life cycles of batteries respectively, in which FIG. 4a is a graph showing a life cycle of a battery using the high power electrode made according to the principles of the present invention and FIG. 4b is a graph showing a life cycle of a battery using a conventionally manufactured electrode.

As shown in FIGS. 4a and 4b, it would be understood that an electrode found with micro pores created by including EC has an improved life cycle rather than the other case, that is, when compared to the battery with a conventionally manufactured electrode represented by FIG. 4b. The following Table 2 numerically shows change of the life cycle mentioned above. From Table 2, it may be seen that a battery using the electrode made according to the principles of the present invention shows a better life cycle than a battery using a conventionally manufactured electrode.

TABLE 2

| | |
|---|---|
| EC micro-pore electrode | Conventional electrode |

| | Remained | Ratio | Remained | Ratio |
|---|---|---|---|---|
| | capacity (mAh/g) | (%) | Capacity (mAh/g) | (%) |
| 1^{st} | 150.30 | 100 | 138.05 | 100 |
| 10^{th} | 145.23 | 96.6 | 131.26 | 95.1 |
| 50^{th} | 125.96 | 83.8 | 101.46 | 73.5 |

The foregoing paragraphs explain the details of a method for manufacturing a high power electrode for a lithium secondary battery. This method is capable of further improving the high current discharge capacity of a battery by forming micro-pores in the electrode for a lithium secondary battery in an inexpensive and easily implemented way, so that electrolyte may freely move into the pores while the battery is being manufactured.

As described above, the method for manufacturing a high power electrode for a lithium secondary battery enables the creation of a high power electrode by the expedient of forming micro-pores in the electrode with the use of EC, thereby substantially improving the life cycle and the discharge capacity of a battery incorporating the electrode. In addition, because the practice of the present invention enables the manufacture of a battery without the use of environmental hormones such as DBP, and does not require any separate extraction process that uses either methanol or ether, the present invention may reduce time and cost for the processes, improve workplace safety, and prevent environmental pollution.

1. A method for manufacturing a high power electrode for a lithium secondary battery, comprising:
(a) preparing EC (ethylene carbonate) solution by dissolving EC crystals in a solvent;
(b) preparing a binder solution by dissolving a binder in a solvent, and then adding an electrode active material and a conductive material of a desired composition to the binder solution and mixing them sufficiently;
(c) adding a predetermined amount of the EC solution prepared in the step (a) to the solution obtained in the step (b) and stirring them sufficiently so as to make a slurry as an electrode binder to be coated on an electrode;
(d) coating the slurry on a collector and sufficiently drying the coated slurry at a predetermined temperature; and
(e) compressing a dried electrode structure at a predetermined pressure after the coated slurry is dried so as to make a final electrode.

2. The method for manufacturing a high power electrode for a lithium secondary battery according to claim 1, further comprising, before the slurry is coated on the collector in the step (d),
degassing the slurry in a vacuum.

3. The method for manufacturing a high power electrode for a lithium secondary battery according to claim 1,
wherein the solvent used in the step (a) is selected from the group consisting of acetone, acetonitrile and NMP (n-methyl pyrrolidone).

4. The method for manufacturing a high power electrode for a lithium secondary battery according to claim 1,
wherein the binder used in the step (b) is selected from the group consisting of PVDF (poly-vinylidone fluoride) and HFP (hexafluoropropylene).

5. The method for manufacturing a high power electrode for a lithium secondary battery according to claim 1,
wherein the electrode active material used in the step (b) is selected from the group consisting essentially of LiCoO₂, LiNixMnyCo(1-x-y)O₂, LiMn₂O₄ and LiNiO₂.

6. The method for manufacturing a high power electrode for a lithium secondary battery according to claim 1,
wherein the temperature for drying in the step (d) is kept in the range of approximately 120° C. to approximately 140° C.

7. The method for manufacturing a high power electrode for a lithium secondary battery according to claim 1,
wherein the pressure for compressing in the step (e) is kept in the range of approximately 500 kg/cm2 to approximately 1500 kg/cm2.

8. A method for manufacturing a high power electrode for a lithium secondary battery, comprising:
preparing an ethylene carbonate solution by dissolving ethylene carbonate crystals in a solvent;
preparing a binder solution by dissolving a binder in a solvent;
mixing an active electrode material and an electrically conductive material in the binder solution;
making a slurry by mixing a predetermined amount of the ethylene carbonate solution with the binder solution;
forming an electrode structure by coating a collector with the slurry and then drying the coated slurry; and
making a final electrode by compressing the electrode structure at a predetermined pressure.

9. The method of claim 8, further comprised of degassing the slurry in a vacuum before the collector is coated with the slurry.

10. The method of claim 8, comprised of dissolving the ethylene carbonate crystals in a solvent selected from the group consisting essentially of acetone, acetonitrile and n-methyl pyrrolidone.

11. The method of claim 8, comprised of selecting the binder from the group consisting essentially of poly-vinylidone fluoride and hexafluoropropylene.

12. The method of claim 8, comprised of selecting the active electrode material from the group consisting essentially of LiCoO₂, LiNixMnyCo(1-x-y)O₂, LiMn₂O₄ and LiNiO₂.

13. The method of claim 8, comprised of maintaining the electrode structure coated with the slurry within an environment exhibiting a temperature in a range of between approximately 120° C. and approximately 140° C. while drying the coated slurry.

14. The method of claim 8, comprised of maintaining a pressure within a range of approximately 500 kg/cm2 to approximately 1500 kg/cm2 while compressing the electrode structure.

15. A method for manufacturing a high power electrode for a lithium secondary battery, comprising:
preparing an ethylene carbonate solution;
preparing a binder solution comprised of a binder, an active electrode material and an electrically conductive material;
making a slurry by mixing a predetermined amount of the ethylene carbonate solution with the binder solution;
forming an electrode structure by coating a collector with the slurry; and
making a final electrode by compressing the electrode structure at a predetermined pressure.

16. The method of claim 15, further comprised of degassing the slurry in a vacuum before the collector is coated with the slurry.

17. The method of claim 15, comprised of preparing the ethylene carbonate solution by dissolving ethylene carbonate crystals in a solvent selected from the group consisting essentially of acetone, acetonitrile and n-methyl pyrrolidone.

18. The method of claim 15, comprised of preparing the binder solution with a binder selected from the group consisting essentially of poly-vinylidone fluoride and hexafluoropropylene.

19. The method of claim 15, comprised of selecting the active electrode material from the group consisting essentially of LiCoO₂, LiNixMnyCo(1-x-y)O₂, LiMn₂O₄ and LiNiO₂.

20. The method of claim 15, comprised of maintaining the electrode structure coated with the slurry within an environment exhibiting a temperature in a range of between approximately 120° C. and approximately 140° C. while drying the coated slurry.

21. The method of claim 15, comprised of maintaining a pressure within a range of approximately 500 kg/cm2 to approximately 1500 kg/cm2 while compressing the electrode structure.
